(19) United States
(12) Patent Application Publication
(10) Pub. No.: US 2023/0197098 A1
(43) Pub. Date: Jun. 22, 2023

(54) SYSTEM AND METHOD FOR REMOVING NOISE AND ECHO FOR MULTI-PARTY VIDEO CONFERENCE OR VIDEO EDUCATION

(71) Applicant: ONTHELIVE CO., LTD., Seoul (KR)

(72) Inventor: Sung Uk YANG, Seoul (KR)

(73) Assignee: ONTHELIVE CO., LTD., Seoul (KR)

(21) Appl. No.: 18/012,663

(22) PCT Filed: Dec. 2, 2022
(86) PCT No.: PCT/KR2022/019468

§ 371 Date: Dec. 23, 2022

(30) Foreign Application Priority Data
Dec. 15, 2021 (KR) 10-2021-0179358

(51) Int. Cl. G10L 21/0232; G10L 21/0224

(52) U.S. Cl. CPC G10L 21/0232; G10L 21/0224; G10L 2021/02082

(57) ABSTRACT

Disclosed is a system and method for removing noise and echo for multi-party video conference or video education, wherein the system for removing noises and echoes includes a sound reception module preprocessing analog sounds received through a microphone into digital sounds that a deep learning model can learn and infer, the deep learning module learns the digital sounds preprocessed by the sound reception module through a plurality of deep learning models, and inferring a user voice using a real-time service model obtained by light-weighting a specific deep learning model of the plurality of deep learning mode, and a sound output module outputting only a digital sound inferred as the user voice by the real-time service model to an external speaker or a virtual audio device.

### TECHNICAL FIELD

The present disclosure relates to a technology of improve the quality of sound in multi-party video conference or video education. In more detail, the present disclosure relates to a technology of removing noises and echoes for multi-party video conference or video education, the technology learning noises and echoes included in a sound signal that is input from the outside through a deep learning model based on various methods, and removing noises and echoes from an input sound in accordance with the result of such learning in actual video conference or video education.

### BACKGROUND ART

Most industrial fields are being hit by globally spreading and prolonged COVID-19 and strong ‘social distance’ has been enforced to prevent COVID-19, whereby modern people are forcibly seeing an untact, that is, non-face-to-face age. However, unlike global economic slowdown, non-face-to-face industries such as Unified Communication and Collaboration (UC&C), a cloud service, online commerce, and Over-The-Top (OTT) are greatly growing. In particular, the interest in a video conference is increasing due to the change of work and education into a digital type, and accordingly, the scale of the global video conference market is expected to greatly increase from 14 billion dollars in 2019 to 50 billion dollars in 2026. In general, a video conference, which may be considered as a real-time visual connection for communication between two or more people at different places, initially started with transmission of static images and texts between two locations and is currently being developed into a system that can transmit full motion video images and high quality audio between several locations. However, in spite of this development of a system, at present, the most inconvenient part that participants of a video conference feel is the quality of sound in a video conference, that is, noises and echoes (howling) that are generated in a conference. Current noise removal technologies are generally based on only an offset signal type that blocks a sound using a sound by transmitting a sound wave that offsets surrounding noises, and a method of muting the microphones of participants who do not speak is applied to remove echoes, but it cannot fundamentally solve howling caused by a subject speaker or other people.

### DISCLOSURE

### Technical Problem

An objective of the present disclosure is to provide a system that can learn noises and echoes included in an external input signal using a plurality of deep learning manners and can remove in real time noises and echoes from an external input signal in accordance with a model optimized after learning in actual video conference or video education.

Another objective of the present disclosure is to provide a method that can learn noises and echoes included in an external input signal using a plurality of deep learning manners and can remove in real time noises and echoes from an external input signal in accordance with a model optimized after learning in actual video conference or video education.

### Technical Solution

A system for removing noises and echoes for multi-part video conference or video education according to an embodiment of the present disclosure includes: a sound reception module preprocessing analog sounds received through a microphone into digital sounds that a deep learning model can learn and infer; the deep learning module learns the digital sounds preprocessed by the sound reception module through a plurality of deep learning models, and inferring a user voice using a real-time service model obtained by light-weighting a specific deep learning model of the plurality of deep learning mode; and a sound output module outputting only a digital sound inferred as the user voice by the real-time service model to an external speaker or a virtual audio device.

The sound reception module includes: a sound receiver converting the received analog sound into a digital signal; a down-sampler performing down-sampling on the converted digital sound in accordance with a predetermined sampling rate; a mute remover removing a mute region (silence) where there is no signal over a predetermined time in the down-sampled digital sound; and a sound slicer dividing the digital sound with the mute region removed into predetermined time sections, thereby performing the preprocessing.

The deep learning module includes: a frequency domain converter converting time domain data of each of the digital sounds preprocessed by the sound reception module into time and frequency domain data through Short-Time Fourier Transform (STFT); a first deep learning unit classifying and learning the time and frequency domain data converted by the frequency domain converter in accordance with frequency relevance according to time variation; a frequency reverse converter reversing each of the signals classified by the first deep learning unit into time domain data; a second deep learning unit reclassifying and learning the time domain data reversed by the frequency reverse converter through an image recognition model; and a service optimizer creating the real-time service model by applying quantization or pruning to a deep learning model of the first deep learning unit.

The first deep learning unit classifies and learns the time and frequency domain data in accordance with frequency relevance according to time variation using a Long Short-Term Memory model (LSTM) as the deep learning model.

Depending on embodiments, the second deep learning unit reclassifies and learns the time domain data using 1D-convolution as the image recognition model.

Depending on embodiments, the service optimizer creates the real-time service model by performing float16 quantization on a weight of the deep learning model of the first deep learning unit.

Meanwhile, the sound output module includes: a sound reconstructor reconstructing only the digital sound inferred as the user voice into time domain data except for digital sounds inferred as noises and echoes in the digital sounds inferred by the real-time service model; an up-sampler performing up-sampling on the digital sound reconstructed by the sound reconstructor in accordance with a predetermined up-sampling rate; and a sound output unit transmitting the digital sound up-sampled by the up-sampler as a clean audio frequency to the virtual audio device or converting the digital sound into an analog sound and transmitting the analog sound to the speaker.

A method of removing noises and echoes for multi-part video conference or video education according to an embodiment of the present disclosure includes: a step in which a sound reception module preprocesses analog sounds received through a microphone into digital sounds that a deep learning model can learn and infer; a step in which the deep learning module learns the digital sounds preprocessed by the sound reception module through a plurality of deep learning models; a step in which the deep learning module creates a real-time service model by light-weighting a specific deep learning model of the plurality of deep learning models for inferring after the learning; a step in which the deep learning module infers a user voice from the digital sounds preprocessed by the sound reception module through the created real-time service model; and a step in which a sound output module outputs the digital sound inferred as the user voice by the deep learning module to an external speaker or a virtual audio device.

Depending on embodiments, the step in which a sound reception module preprocesses includes: a step in which a sound receiver receives the analog sounds including a user voice and various noises and echoes generated in a user environment through the microphone; a step in which the sound receiver converts the received analog signals into digital signals through an analog-digital converter; a step in which a down-sampler performs the digital sounds converted by the sound receiver in accordance with a predetermined sampling rate; a step in which a mute remover removes a mute region where there is no signal over a predetermined time in the digital sound down-sampled by the down-sampler; and a step in which a sound slicer divides and stores the digital sound with the mute region removed by the mute remover into sections according to a predetermined time.

Depending on embodiments, the step in which the deep learning module learns includes: a step in which a frequency domain converter converts time domain data of each of the digital sounds preprocessed by the sound reception module into time and frequency domain data through Short-Time Fourier Transform (STFT); a step in which a first deep learning unit classifies and learns the time and frequency domain data converted by the frequency domain converter in accordance with frequency relevance according to time variation using a Long Short-Term Memory model (LSTM); a step in which the first deep learning unit calculates a frequency magnitude that is a magnitude of an amplitude value of each of signals classified in accordance with the frequency relevance according to time variation; a step in which a frequency reverse converter reverses each of the signals classified by the first deep learning unit into time domain data in accordance with the calculated frequency magnitude by performing Reverse Fast Fourier Transform (IFFT); and a step in which a second deep learning unit reclassifies and learns waveform images of the time domain data reversed by the frequency reverse converter using 1D-convolution.

Meanwhile, the step in which the deep learning module creates a real-time service model is to create the real-time service model by performing float16 quantization on a weight of the long short-term memory model of the first deep learning unit by means of a service optimizer.

Depending on embodiments, the step in which a sound output module outputs includes: a step in which a sound reconstructor reconstructs only the digital sound inferred as the user voice into time domain data except for digital sounds inferred as noises and echoes in the digital sounds inferred by the deep learning module; a step in which an up-sampler performs up-sampling on the digital sound reconstructed by the sound reconstructor in accordance with a predetermined up-sampling rate; and a sound output unit transmitting the digital sound up-sampled by the up-sampler as a clean audio frequency to the virtual audio device or converting the digital sound into an analog sound and transmitting the analog sound to the external speaker.

### Advantageous Effects

The system and method for removing noises and echoes for multi-party video conference or video education according to an embodiment of the present disclosure has an effect that it is possible to learn noises and echoes through various deep learning models and it is possible to accurately remove in real time various noises and echoes that may be generated in multi-party video conference or education in accordance with a deep learning service model optimized after learning in actual video conference or education.

### DESCRIPTION OF DRAWINGS

FIG. 1 is a block diagram showing the internal configuration of a system for removing noises and echoes for multi-party video conference or video education according to an embodiment of the present disclosure.

FIG. 2 is a block diagram showing the internal configuration of a deep learning module shown in FIG. 1.

FIG. 3 is a flowchart illustrating a method of removing noises and echoes for multi-party video conference or video education according to an embodiment of the present disclosure.

FIG. 4 is a flowchart illustrating in detail a preprocessing step of a sound reception module shown in FIG. 3.

FIG. 5 is a flowchart illustrating in detail a learning step of a deep learning model shown in FIG. 3.

FIG. 6 is a flowchart illustrating in detail an inferring step of a deep learning model shown in FIG. 3.

FIG. 7 is a flowchart illustrating in detail an outputting step of a sound output module shown in FIG. 3.

### BEST MODE FOR INVENTION

Specific structural and functional description about embodiments according to the concept of the present disclosure disclosed herein is exemplified only to describe the embodiments according to the concept of the present disclosure and the embodiments according to the concept of the present disclosure may be implemented in various ways and are not limited to the embodiments described herein.

Embodiments described herein may be changed in various ways and various shapes, so specific embodiments are shown in the drawings and will be described in detail in this specification. However, it should be understood that the exemplary embodiments according to the concept of the present disclosure are not limited to the specific examples, but all of modifications, equivalents, and substitutions are included in the scope and spirit of the present disclosure.

The present disclosure will be described hereafter in detail by describing exemplary embodiments of the present disclosure with reference to the accompanying drawings.

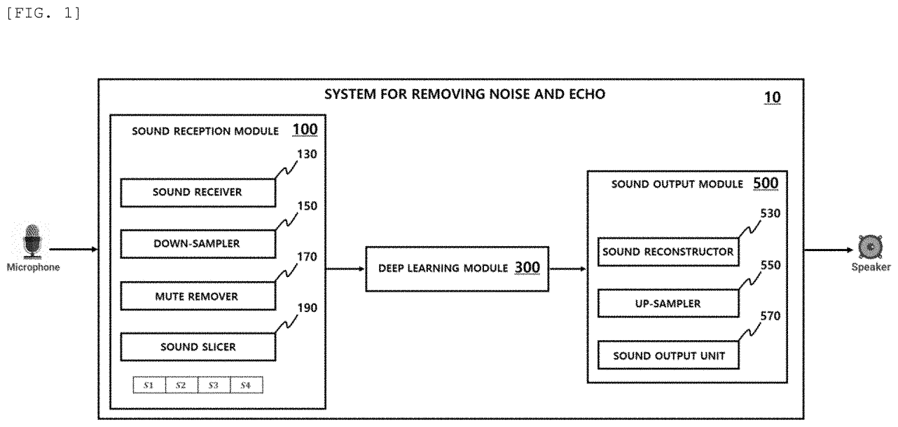

FIG. 1 is a block diagram showing the internal configuration of a system 10 for removing noises and echoes for multi-party video conference or video education according to an embodiment of the present disclosure.

Referring to FIG. 1, a system 10 for removing noises and echoes for multi-party video conference or video education (hereafter, referred to as ‘system 10 for removing noises and echoes) includes a sound reception module 100, a deep learning module 300, and a sound output module 500.

First, the sound reception module 100 performs preprocessing to be able to learn and infer sounds received from various environments of several users participating in multi-party video conference or video education, and includes a sound receiver 130, a down-sampler 150, a mute remover 170, and a sound slicer 190.

The sound receiver 130 included in the sound reception module 100 receives various sounds (mixed audio frequency) simultaneously input from a user environment through a microphone.

The various sounds input from a user environment may be not only the sound of the user, but various noises that are generated around the user, may be a feedback sound (echo or howling) of himself/herself input through a speaker, and may be voices of other users input through a speaker or various noises generated around other users.

Further, the noises may include all of noises including not only common noises that are generated by objects, but stationary noises such as a white noise and non-stationary noises such as a chirp noise.

The sound receiver 130 converts an analog sound input through the microphone into a digital sound through an analog-digital converter (ADC) and then transmits the digital sound to the down-sampler 150.

The down-sampler 150 performs down-sampling on the transmitted digital sound in accordance with a predetermined sampling rate, and the predetermined down-sampling rate may be set as 16 kHz, depending on embodiments.

Meanwhile, the part where there is no signal in the down-sampled sound is a part that is not used or does not need to be used for learning or inferring by the deep learning module 300, so it needs to be removed in advance.

Accordingly, the mute remover 170 removes a region (silence) where there is no signal over a predetermined time in the sound down-sampled by the down-sampler 150.

Sequentially, the sound slicer 190 divides the digital sound with the mute region removed by the mute remover 170 into sections according to a predetermined time.

Depending on embodiments, the predetermined time may be set as 32 ms, and the sound slicer 190 stores the digital sounds divided into the predetermined sections in audio buffers S1 to S4, respectively.

In the specification, four audio buffers are shown, but this is only for convenience of description, and it is apparent that the number of the audio buffers may be set as a number smaller or larger than 4, depending on setting.

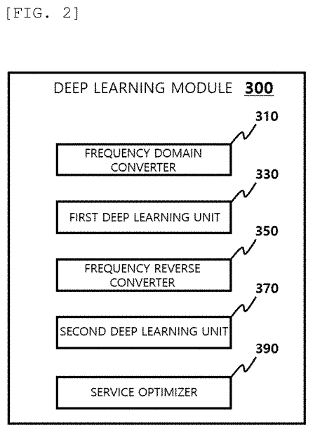

FIG. 2 is a block diagram showing the internal configuration of the deep learning module 300 shown in FIG. 1.

Referring to FIGS. 1 and 2, the deep learning module 300 serves to learn and infer a user voice, noises, and echoes (howling) from a digital sound preprocessed by the sound reception module 100, and includes a frequency domain converter 310, a first deep learning unit 330, a frequency reverse converter 350, a second deep learning unit 370, and a service optimizer 390.

In this case, the learning may mean a process of accurately classifying and learning a user voice, noises, and echoes from a digital sound through a deep learning model such as the first deep learning unit 330 or the second deep learning unit 370 to be described below, and the inferring may means a process of separating and removing noises and echoes in real time from a digital sound that is input latter on the basis of the learning result and a model optimization method created by the service optimizer 390.

First, the frequency domain converter 310 converts time domain data (e.g., audio frequency data) of each of the digital sounds stored in the audio buffers S1 to S4 into time and frequency domain data (e.g., vector data) for learning and inferring by the first deep learning unit 330.

In this case, the frequency domain converter 310 creates time and frequency domain data for a corresponding digital sound by performing Short-Time Fourier Transform (STFT) to be able to solve the problem of a loss of time information that is generated in Fourier Transform, in more detail, Discrete Fourier Transform (DFT).

Depending on embodiments, the frequency domain converter 310 can set a window size of the STFT as 256 points and can create the time and frequency domain data for a corresponding digital sound into a spectrogram.

The spectrogram can visualize not only a frequency and amplitude information, but time information in Fourier Transform, which may be very important information in analysis of a non-stationary sound to be described below.

Thereafter, the frequency domain converter 310 transmits vector data that are the time and frequency domain data for each of the created corresponding digital sounds to the first deep learning unit 330.

Meanwhile, general Convolutional Neural Network (CNN) learning is specified for image recognition and classification in a computer vision, so it is not suitable for learning a sound including time-series data.

Further, a general Recurrent Neural Network (RNN) has a problem that the learning ability greatly decreases when the distance between relevant information and a point where the information is used is large.

In other words, the general CNN is not suitable for learning time-series data and the general RNN has problems of gradient vanishing and gradient exploding in Back Propagation Through Time (BPTT).

Accordingly, the first deep learning unit 330 classifies and supervised-learns time and frequency domain data for a corresponding digital sound using a Long Short-Term Memory model (LSTM) to solve the problems.

In this case, the first learning unit 330 can receive, classify, and learn time and frequency domain data for a corresponding digital sound in the unit of 32 ms from the frequency domain converter 310, the number of cells of the entire LSTM may be set as 1024, and drop-out that is a regularization process for preventing overfitting between cells of the LSTM may be used.

That is, the first deep learning unit 330 can find out frequency relevance according to time variation through the LSTM, so it can separate signals S1 to Sn included in vector data transmitted from the frequency domain converter 310.

Thereafter, the first deep learning unit 330 classifies the separated signals S1 to Sn in relation to what signals E1 to En the separated signals correspond to, respectively, and calculates a frequency magnitude that is the magnitude of an amplitude value of each of the classified corresponding signals E1 to En.

For example, assuming that the first deep learning unit 350 classifies four signals S1 to S4 included in the transmitted vector data, the first deep learning unit 350 can classify and learn a first signal S1 of four signals S1 to S4 separated through the LSTM as a voice E1 of a person, classify and learn a second signal S2 and a third signal S3 as a noise E2, and classify and learn a fourth signal S4 as an echo E3.

In this case, the noise E2 may be various noises (e.g., S3) such as not only general noises (e.g., S2) that are generated in a video conference such as the sound of typing on a keyboard, but a white noise and a non-stationary noise.

That is, the second signal S2 and the third signal S3 may be included in the second classified signal E2 that is a noise.

Further, the first deep learning unit 330 calculates a frequency magnitude of each of the classified signals E1 to E4, and for example, calculates the frequency magnitude of the first classified signal E1 corresponding to a voice of a person as a magnitude m1 of the first signal S1, calculates the frequency magnitude of the second classified signal E2 corresponding to a noise as the magnitudes m2 and m3 of the second signal S2 and the third signal S3, and calculates the frequency magnitude of the third classified signal E3 corresponding to an echo as the magnitude m4 of the fourth signal S4.

Thereafter, the first deep learning unit 330 transmits the classified signals E1 to E3 with the calculated corresponding frequency magnitudes m1, m2, m3, and m4 to the frequency reverse converter 350.

Meanwhile, the frequency reverse converter 350 reverses the classified signals E1 to E3 transmitted from the first deep learning unit 330 back into the time domain and provides the classified signals to the second deep learning unit 370.

In this case, the first signal S1 is reversed into a time domain t1 in the first classified signal E1, the second signal S2 and the third signal S3 are reversed into time domains t2 and t3, respectively, in the second classified signal E2, and the fourth signal S4 is reversed into a time domain t4 in the third classified signal E3.

That is, the frequency reverse converter 350 performs Reverse Fast Fourier Transform (IFFT) on the signals (e.g., E1 to En) classified by the first deep learning unit 330 into time domain data (audio frequency data) in consideration of the frequency magnitudes (e.g., m1 to mn), and transmits the reversed signals t1 to tn to the second deep learning unit 370.

Meanwhile, the Convolutional Neural Network (CNN) has been known as a representative deep learning method that can classify an input image in relation to what image the input image is by extracting features from the input image.

The second deep learning unit 370 more precisely classifies and learns an input image from the waveform image (shape) of each of the reversed signals t1 to tn transmitted from the frequency reverse converter 350 using the CNN.

Depending on embodiments, the second deep learning unit 370 classifies and learns the time domain data t1 to tn transmitted from the frequency reverse converter 350 using 1D-convolution of the CNN.

The 1D-convolution is slightly suitable for time-series analysis or text analysis even though it is the same CNN, and in this case, the ‘1D’ means that a kernel for convolution and an applied data sequence have a 1D shape.

That is, since the time domain data t1 to tn transmitted from the frequency reverse converter 350, as described above, each include variation of an amplitude or variation of a frequency according to time, the second deep learning unit 370 according to an embodiment of the present disclosure classifies and learns the time domain data t1 to tn transmitted from the frequency reverse converter 350 through 1D convolution.

In particular, the second deep learning unit 370 can secure minimization of an operation amount and a real-time feature of operation for removing noises and echoes in comparison to a general 2D CNN (or 3D CNN) by performing classifying and learning according to the 3D convolution.

That is, the second deep learning unit 370 more precisely and quickly classifies the time domain data t1 to tn transmitted from the frequency reverse converter 350 using the 1D convolution.

For example, the second deep learning unit 370 can classify a first reversed signal t1 for the first signal S1 as a voice of a person, classify a second reversed signal t2 for the second signal S2 as a vehicle noise sound e2 of noises, classify a third reversed signal t3 for the third signal S3 as a construction sound e3 of noises, and classify a fourth reversed signal t4 for the fourth signal S4 as a feedback echo e4 transmitted through a speaker.

That is, the second deep learning unit 370 can check again whether the result classified by the first deep learning 330 using the 1D convolution is appropriate, and can classify again in more detail the result classified by the first deep learning unit 330.

Thereafter, the second deep learning unit 370 can transmit the time domain data t1 to tn and the classified information e1 to e4 corresponding to the time domain data, respectively, to the sound output module 500.

Meanwhile, the service optimizer 390 creates a real-time service model obtained by applying optimization such as quantization or pruning and a light-weighting method to a deep learning model.

The real-time service model means a deep learning inference model, which may be considered as a model optimized and light-weighted such that a deep learning model that accurately classifies and learns a user sound, noises, and echoes from an input sound can be actually implemented in real time in a multi-party video conference.

The service optimizer 390 can create the real-time service model by performing quantization on the deep learning models of the first deep learning unit 330 and the second deep learning unit 370.

Depending on embodiments, since the second deep learning unit 370 uses already 1D convolution that is considerably less in operation amount and has a greatly high operation speed in comparison to a general CNN, the service optimizer 390 can create the real-time service model by performing quantization on the LSTM that is the deep learning model of the first deep learning unit 330.

In this case, the LSTM of the first deep learning unit 330 expresses parameters such as a weight or an activation value as a 32-bit floating point, so the service optimizer 390 can create a real-time service model by applying float16 quantization of Post-Training Quantization (PTQ) to the LSTM of the first deep learning unit 330.

Through the real-time service model created in this way (a composite inference model composed of a float16-quantized LSTM model and a 1D-convolution model or a single inference model composed of only a float16-quantized LSTM model), the service optimizer 390 infers a user voice for a digital sound preprocessed and input from the sound reception module 100 after learning by the first learning unit 330 and the second learning unit 370 described above.

Accordingly, the service optimizer 390 classifies the signals S1 to Sn included in the vector data transmitted from the frequency domain converter 310 in relation to what signals E1 to En the signals S1 to Sn correspond to, respectively, through the real-time service model (float16-quantized LSTM model) that is considerably fast and is not that much low in accuracy in comparison to the deep learning model (LSTM) of the first deep learning unit 330.

Thereafter, the process of calculating the frequency magnitude that is the magnitude of the amplitude value of each of the classified corresponding signals E1 to En and of transmitting the classified signals E1 to En together with the calculated corresponding frequency magnitudes m1, m2, m3, and m4 to the frequency reverse converter 350 is the same as that described in relation to the first deep learning unit 330.

Further, the process of classifying time domain data t1 to tn transmitted from the frequency reverse converter 350 using 1D convolution and of transmitting the classified information e1 to e4 corresponding to the time domain data, respectively, to the sound output module 500 is the same as that described in relation to the second deep learning unit 370.

Referring to FIG. 1 again, the sound output module 500 selectively outputs only a user voice (e.g., t1) from the time domain data t1 to tn transmitted from the second deep learning unit 370 or the service optimizer 390 of the deep learning module 300 and the classified information e1 to e4 corresponding to the time domain data, respectively, and includes a sound reconstructor 530, an up-sampler 550, and a sound output unit 570.

The sound reconstructor 530 reconstructs time domain data (audio frequency data) except for signals corresponding to noises t2 and t3 or the echo t4 other than the signal t1 corresponding to the user voice.

Thereafter, the sound reconstructor 530 transmits a digital sound (i.e., t1) corresponding to the reconstructed time domain data to the up-sampler 550.

The up-sampler 550 performs up-sampling on the reconstructed digital sound (i.e., t1) in accordance with a predetermined sampling rate, and the predetermined up-sampling rate may be set as 16 kHz, depending on embodiments.

The sound output unit 570 can output an up-sampled signal from the up-sampler 530 as a clean audio frequency with noises and echoes removed, and the outputting may be outputting to a speaker or transferring to a virtual audio device through a digital-analog converter (DAC).

Depending on embodiments, the sound reconstructor 530 may directly transmit the time domain data (audio frequency data) reconstructed as described above to the sound output unit 570 rather than the up-sampler 550.

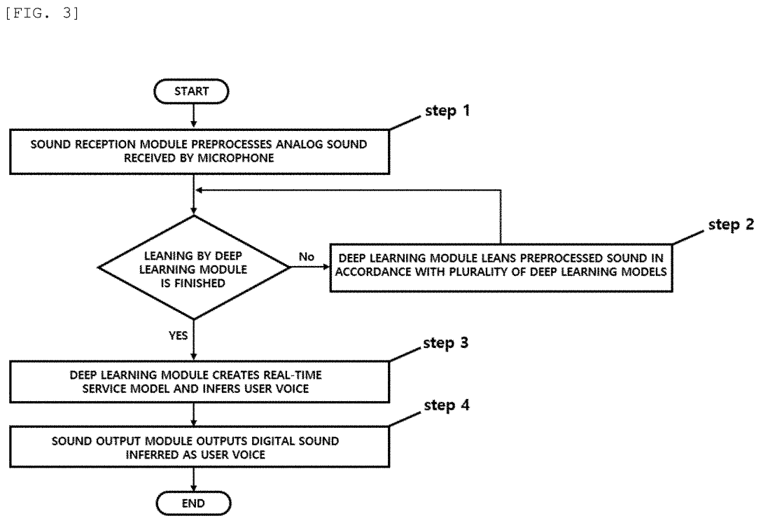

FIG. 3 is a flowchart illustrating a method of removing noises and echoes for multi-party video conference or video education according to an embodiment of the present disclosure.

Referring to FIGS. 1 to 3, a method of removing noises and echoes for multi-party video conference or video education (hereafter, referred to as a ‘method of removing noises and echoes’) includes a step in which the sound reception module 100 preprocesses an analog signal received through a microphone such that the deep learning module 300 can learn and infer the analog signal (step 1), and a step in which the deep learning module 300 learns the digital sound preprocessed by the sound reception module 100 through a plurality of deep learning models (e.g., 330 and 370) (step 2).

Further, the method of removing noises and echoes include: a step in which the deep learning module 300 creates a real-time service model by light-weighting a specific deep learning model 330 of the plurality of deep learning models 330 and 370, performs learning through the created real-time service model, and then infers a user voice from a digital sound preprocessed and input from the sound reception module 100 (step 3) when the learning step (step 2) is finished; and a step in which the sound output module 500 outputs the digital sound inferred as a user voice from the deep learning module 300 to an external speaker or a virtual audio device (step 4).

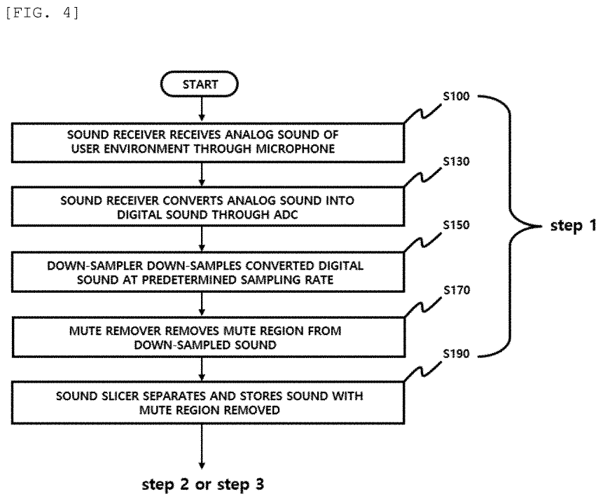

FIG. 4 is a flowchart illustrating in more detail the preprocessing step (step 1) of the sound reception module 100 shown in FIG. 3.

Referring to FIGS. 1 to 4, the sound receiver 130 of the sound reception module 100 receives various analog sounds including a voice of a user and various noises and echoes generated in a user environment through a microphone (S100).

Thereafter, the sound receiver 130 converts the analog sounds input through the microphone into digital sounds through an analog-digital converter (ADC) (S130), and performs down-sampling on the digital sounds converted by the sound receiver 130 in accordance with a predetermined sampling rate (S150).

The mute remover 170 removes a mute region where there is no signal over a predetermined time in the digital sounds down-sampled by the down-sampler 150 (S170).

Sequentially, the sound slicer 190 divides the digital sounds with the mute region removed by the mute remover 170 into sections according to a predetermined time, and stores the digital sounds S1 to S4 divided into the predetermined sections to audio buffers, respectively, (S190).

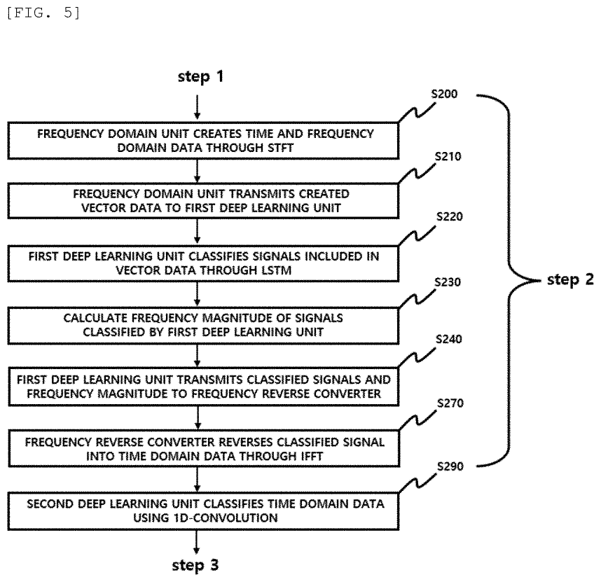

FIG. 5 is a flowchart illustrating in more detail the learning step (step 2) of the deep learning module 300 shown in FIG. 3.

Referring to FIGS. 1 to 5, the frequency domain converter 310 of the deep learning module 300 creates the time domain data of each of the digital sounds S1 to S4 stored in the audio buffers into time and frequency domain data by applying Short-Time Fourier Transform (S200) for learning and inferring by the first deep learning 330 (S200).

Thereafter, the frequency domain converter 310 transmits vector data that are the time and frequency domain data for each of the created corresponding digital sounds to the first deep learning unit 330 (S210).

The first deep learning unit 330 separates the signals S1 to Sn included in the vector data transmitted from the frequency domain converter 310 using a Long Short-Term Memory model (LSTM), and classifies the separated signals S1 to Sn in relation to what signals E1 to En the separated signals correspond to, respectively. (S220).

For example, assuming that the first deep learning unit 350 classifies four signals S1 to S4 included in the transmitted vector data, the first deep learning unit 350 can classify and learn a first signal S1 of four signals S1 to S4 separated through the LSTM as a voice E1 of a person, classify and learn a second signal S2 and a third signal S3 as a noise E2, and classify and learn a fourth signal S4 as an echo E3.

Sequentially, the first deep learning unit 330 calculates a frequency magnitude that is the magnitude of an amplitude value of each of the classified corresponding signals E1 to En (S230).

For example, the first deep learning unit 330 calculates the frequency magnitude of the first classified signal E1 corresponding to a voice of a person as a magnitude m1 of the first signal S1, calculates the frequency magnitude of the second classified signal E2 corresponding to a noise as the magnitudes m2 and m3 of the second signal S2 and the third signal S3, and calculates the frequency magnitude of the third classified signal E3 corresponding to an echo as the magnitude m4 of the fourth signal S4.

Thereafter, the first deep learning unit 330 transmits the classified signals E1 to E3 with the calculated corresponding frequency magnitudes m1, m2, m3, and m4 to the frequency reverse converter 350 (S240).

The frequency reverse converter 350 performs Reverse Fast Fourier Transform (IFFT) on the classified signals (e.g., E1 to E3) transmitted from the first deep learning unit 330 into time domain data (audio frequency data) in consideration of the frequency magnitudes (e.g., m1 to mn), and transmits the reversed signals t1 to tn to the second deep learning unit 370 (S250).

In this case, the first signal S1 is reversed into a time domain t1 in the first classified signal E1, the second signal S2 and the third signal S3 are reversed into time domains t2 and t3, respectively, in the second classified signal E2, and the fourth signal S4 is reversed into a time domain t4 in the third classified signal E3.

Sequentially, the second deep learning unit 370 more precisely classifies and learns an input image from the waveform image (shape) of each of the time domain data t1 to tn transmitted from the frequency reverse converter 350 using 1D-convolution (S270).

In particular, the second deep learning unit 370 can secure minimization of an operation amount and a real-time feature of operation for removing noises and echoes in comparison to a general 2D CNN (or 3D CNN) by performing classifying and learning according to the 3D convolution.

For example, the second deep learning unit 370 can classify a first reversed signal t1 for the first signal S1 as a voice of a person, classify a second reversed signal t2 for the second signal S2 as a vehicle noise sound e2 of noises, classify a third reversed signal t3 for the third signal S3 as a construction sound e3 of noises, and classify a fourth reversed signal t4 for the fourth signal S4 as a feedback echo e4 transmitted through a speaker.

That is, the second deep learning unit 370 can check again whether the result classified by the first deep learning 330 using the 1D convolution is appropriate, and can classify again in more detail the result classified by the first deep learning unit 330.

Depending on embodiments, the second deep learning unit 370 can transmit the time domain data t1 to tn and the classified information e1 to e4 corresponding to the time domain data, respectively, to the sound output module 500 (S290).

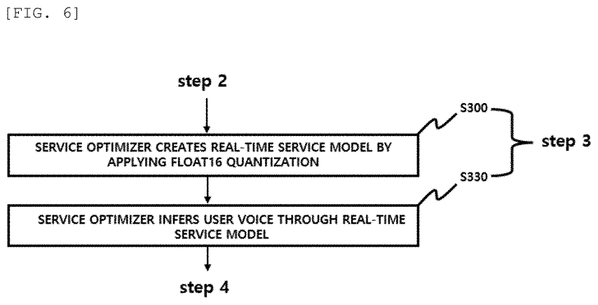

FIG. 6 is a flowchart illustrating in more detail the inferring step (step 3) of the deep learning module 300 shown in FIG. 3.

Referring to FIGS. 1 to 6, the service optimizer 390 creates a real-time service model by applying float16 quantization of Post-Training Quantization (PTQ) to the LSTM that is the deep learning model of the first deep learning unit 330 when learning by deep learning module 300 is finished (e.g., when learning by the first deep learning unit 330 and learning by the second deep learning unit 370 are both finished) (S300).

Of course, the service optimizer 390 may create the real-time service model by performing quantization on all of the deep learning models of the first deep learning unit 330 and the second deep learning unit 370.

However, since the second deep learning unit 370 uses already 1D convolution that is considerably less in operation amount and has a greatly high operation speed in comparison to a general CNN, the service optimizer 390 can create the real-time service model by applying float16 quantization only to the LSTM that is the deep learning model of the first deep learning unit 330 (S300).

Through the real-time service model created in this way (a float16-quantized LSTM model and 1D-convolution), the service optimizer 390 infers a user voice for a digital sound preprocessed and input from the sound reception module 100 after learning by the first learning unit 330 and the second learning unit 370 described above (S330).

Depending on embodiments, the service optimizer 390 may infer a user voice for a digital sound preprocessed and input from the sound reception module 100 after learning by creating only a model obtained by applying float16 quantization to the LSTM of the first deep learning unit 330 as the real-time service model.

As a result, through the real-time service model (an inference model including the float16-quantized LSTM model), the service optimizer 390 infers a user voice for the digital sound preprocessed and input from the sound reception module 100 after the learning step (step 2) (S330).

Further, as described above, the inferring process by the service optimizer 390 is to classify the signals S1 to Sn included in the vector data transmitted from the frequency domain converter 310 in relation to what signals E1 to En the signals S1 to Sn correspond to, respectively, to calculate a frequency magnitude that is the magnitude of an amplitude value of each of the classified corresponding signals E1 to En, and to transmit the classified signals E1 to E3 with the calculated corresponding frequency magnitudes m1, m2, m3, and m4 to the frequency reverse converter 350, which is the same as that described in relation to the first deep learning unit 330.

Further, the inferring process by the service optimizer 390 is to classify time domain data t1 to tn transmitted from the frequency reverse converter 350 using 1D convolution and to transmit the classified information e1 to e4 corresponding to the time domain data, respectively, to the sound output module 500, which is the same as that described in relation to the second deep learning unit 370.

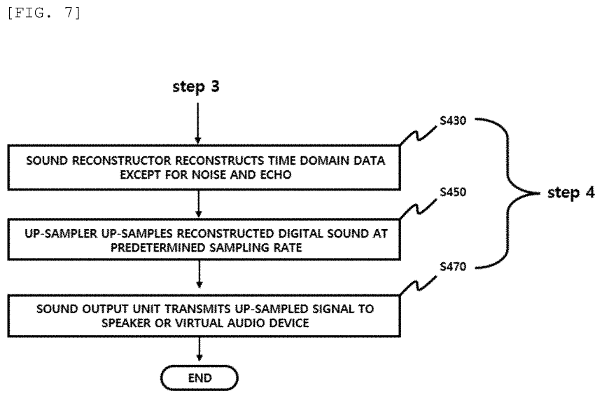

FIG. 7 is a flowchart illustrating in detail an outputting step (step 4) of the sound output module 500 shown in FIG. 3.

Referring to FIGS. 1 to 7, the sound reconstructor 530 of the sound output module 500 reconstructs time domain data except for signals corresponding to noises t2 and t3 or the echo t4 other than the signal t1 corresponding to the user voice from the time domain data t1 to t4 transmitted from the second deep learning unit 370 or the service optimizer 390 and the classified information e1 to e4 corresponding to the time domain data, respectively, and transmits the time domain data to the up-sampler 550 (S430).

The up-sampler 550 performs up-sampling on the reconstructed digital sound (i.e., t1) in accordance with a predetermined sampling rate (S450).

Thereafter, the sound output unit 570 transmits the signal up-sampled by the up-sampler 530 to a speaker or a virtual audio device as a clean audio frequency with noises and echoes removed (S470).

The above description merely explains the spirit of the present disclosure and the present disclosure may be changed and modified in various ways without departing from the spirit of the present disclosure by those skilled in the art.

Accordingly, the embodiments described herein are provided merely not to limit, but to explain the spirit of the present disclosure, and the spirit of the present disclosure is not limited by the embodiments. The protective range of the present disclosure should be construed by the following claims and the scope and spirit of the present disclosure should be construed as being included in the patent right of the present disclosure.

### INDUSTRIAL APPLICABILITY

The present disclosure relates to a technology of removing noises and echoes for multi-party video conference or video education, the technology learning noises and echoes included in a sound signal that is input from the outside through a deep learning model, and removing noises and echoes from an input sound in accordance with the result of such learning in actual video conference or video education. Accordingly, the present disclosure has industrial applicability.

1. A system for removing noises and echoes for multi-part video conference or video education, the system comprising:
a sound reception module preprocessing analog sounds received through a microphone into digital sounds that a deep learning model can learn and infer;
the deep learning module learns the digital sounds preprocessed by the sound reception module through a plurality of deep learning models, and inferring a user voice using a real-time service model obtained by light-weighting a specific deep learning model of the plurality of deep learning models; and
a sound output module outputting only a digital sound inferred as the user voice by the real-time service model to an external speaker or a virtual audio device,
wherein the deep learning module includes:
a frequency domain converter converting time domain data of each of the digital sounds preprocessed by the sound reception module into time and frequency domain data through Short-Time Fourier Transform (STFT);
a first deep learning unit classifying and learning the time and frequency domain data converted by the frequency domain converter in accordance with frequency relevance according to time variation;
a frequency reverse converter reversing each of the signals classified by the first deep learning unit into time domain data;
a second deep learning unit reclassifying and learning the time domain data reversed by the frequency reverse converter through an image recognition model; and
a service optimizer creating the real-time service model by applying quantization or pruning to a deep learning model of the first deep learning unit,
wherein the first deep learning unit classifies and learns the time and frequency domain data in accordance with frequency relevance according to time variation using a Long Short-Term Memory model (LSTM) as the deep learning model,
the second deep learning unit reclassifies and learns the time domain data using 1D-convolution as the image recognition model, and
the service optimizer creates the real-time service model by performing float16 quantization on a weight of the deep learning model of the first deep learning unit.

2. The system of claim 1, wherein the sound reception module includes:
a sound receiver converting the received analog sound into a digital signal;
a down-sampler performing down-sampling on the converted digital sound in accordance with a predetermined sampling rate;
a mute remover removing a mute region (silence) where there is no signal over a predetermined time in the down-sampled digital sound; and
a sound slicer dividing the digital sound with the mute region removed into predetermined time sections.

3. The system of claim 1, wherein the sound output module includes:
a sound reconstructor reconstructing only the digital sound inferred as the user voice into time domain data except for digital sounds inferred as noises and echoes in the digital sounds inferred by the real-time service model;
an up-sampler performing up-sampling on the digital sound reconstructed by the sound reconstructor in accordance with a predetermined up-sampling rate; and
a sound output unit transmitting the digital sound up-sampled by the up-sampler as a clean audio frequency to the virtual audio device or converting the digital sound into an analog sound and transmitting the analog sound to the speaker.

4. A method of removing noises and echoes for multi-part video conference or video education, the method comprising:
a step in which a sound reception module preprocesses analog sounds received through a microphone into digital sounds that a deep learning model can learn and infer;
a step in which the deep learning module learns the digital sounds preprocessed by the sound reception module through a plurality of deep learning models;
a step in which the deep learning module creates a real-time service model by light-weighting a specific deep learning model of the plurality of deep learning models for inferring after the learning;
a step in which the deep learning module infers a user voice from the digital sounds preprocessed by the sound reception module through the created real-time service model; and
a step in which a sound output module outputs the digital sound inferred as the user voice by the deep learning module to an external speaker or a virtual audio device,
wherein the step in which the deep learning module learns includes:
a step in which a frequency domain converter converts time domain data of each of the digital sounds preprocessed by the sound reception module into time and frequency domain data through Short-Time Fourier Transform (STFT);
a step in which a first deep learning unit classifies and learns the time and frequency domain data converted by the frequency domain converter in accordance with frequency relevance according to time variation using a Long Short-Term Memory model (LSTM);
a step in which the first deep learning unit calculates a frequency magnitude that is a magnitude of an amplitude value of each of signals classified in accordance with the frequency relevance according to time variation;
a step in which a frequency reverse converter reverses each of the signals classified by the first deep learning unit into time domain data in accordance with the calculated frequency magnitude by performing Reverse Fast Fourier Transform (IFFT); and
a step in which a second deep learning unit reclassifies and learns waveform images of the time domain data reversed by the frequency reverse converter using 1D-convolution,
wherein the step in which the deep learning module creates a real-time service model is to create the real-time service model by performing float16 quantization on a weight of the long short-term memory model of the first deep learning unit by means of a service optimizer.

5. The method of claim 4, wherein the step in which a sound reception module preprocesses includes:
a step in which a sound receiver receives the analog sounds including a user voice and various noises and echoes generated in a user environment through the microphone;
a step in which the sound receiver converts the received analog signals into digital signals through an analog-digital converter;
a step in which a down-sampler performs the digital sounds converted by the sound receiver in accordance with a predetermined sampling rate;
a step in which a mute remover removes a mute region where there is no signal over a predetermined time in the digital sound down-sampled by the down-sampler; and
a step in which a sound slicer divides and stores the digital sound with the mute region removed by the mute remover into sections according to a predetermined time.

6. The method of claim 4, wherein the step in which a sound output module outputs includes:
a step in which a sound reconstructor reconstructs only the digital sound inferred as the user voice into time domain data except for digital sounds inferred as noises and echoes in the digital sounds inferred by the deep learning module;
a step in which an up-sampler performs up-sampling on the digital sound reconstructed by the sound reconstructor in accordance with a predetermined up-sampling rate; and
a step in which a sound output unit transmits the digital sound up-sampled by the up-sampler as a clean audio frequency to the virtual audio device or converting the digital sound into an analog sound and transmitting the analog sound to the external speaker.
